(19) United States
(12) Patent Application Publication
(10) Pub. No.: US 2013/0136973 A1
(43) Pub. Date: May 30, 2013

(54) RECHARGEABLE LITHIUM ION BATTERY WITH SILICON ANODE

(71) Applicant: Ravindra V. Shenoy, Dublin, CA (US)

(72) Inventor: Ravindra V. Shenoy, Dublin, CA (US)

(73) Assignee: QUALCOMM MEMS TECHNOLOGIES, INC., San Diego, CA (US)

(21) Appl. No.: 13/307,294

(22) Filed: Nov. 30, 2011

(51) Int. Cl. H01M 10/0525; H01M 4/131; H01M 10/02; H01M 4/13; H01M 4/64

(52) U.S. Cl. 429/152; 429/209; 429/211; 429/221; 429/224; 429/231.3; 427/554; 427/123; 427/58

(57) ABSTRACT

This disclosure provides systems, methods and apparatus for batch fabrication of a rechargeable lithium-ion battery using a silicon substrate as an anode. In one aspect, a pre-formed silicon substrate is provided. A plurality of first openings can be formed on one side of the substrate, which can have a high height to width aspect ratio. A plurality of second openings can be formed alternatingly, or in interdigitated fashion, with the first openings on another side of the substrate that is opposite the first side. A solid electrolyte layer can be deposited on the second side of the substrate in the second openings, and a cathode material can be formed into the second openings and over the electrolyte layer on the second side of the substrate.

### TECHNICAL FIELD

This disclosure relates to lithium ion batteries using a silicon substrate as an anode.

### DESCRIPTION OF THE RELATED TECHNOLOGY

Lithium is the lightest and most electropositive element, making it well-suited for applications benefiting from high energy density. As such, lithium-ion (Li⁺) batteries have been successfully employed in a large variety of portable and electronic devices, especially in cellular phones and notebook computers. The lithium-ion rechargeable batteries can demonstrate high energy densities, lack of memory effect, and a slow loss of charge when not in use. Beyond portable electronics, the lithium-ion battery is growing in popularity for military, electric vehicle, aerospace, and energy storage applications.

However, increasing battery life while reducing fabrication cost and ability to build larger format batteries for such applications has been a major problem. Higher power and energy densities are chiefly desired by the microelectronics industry, whereas building large format batteries cheaply is a higher priority for larger-scale applications. Batteries for both of these types of applications can be fabricated in a non-batch processing mode, which adds to cost. Batch processing, can be used to simultaneously to fabricate tens or hundreds of battery units, thus reducing the cost of fabricating each single unit, but has tended to produce rather small batteries.

### SUMMARY

The systems, methods and devices of the disclosure each have several innovative aspects, no single one of which is solely responsible for the desirable attributes disclosed herein.

One innovative aspect of the subject matter described in this disclosure can be implemented in a method of manufacturing a lithium-ion battery. The method includes providing a silicon anode substrate, forming a plurality of first openings on a first side of the silicon anode substrate, forming a plurality of second openings alternatingly with the first openings on a second side of the silicon anode substrate opposite the first side, depositing a solid electrolyte on the second side of the silicon anode substrate in the second openings, and forming a cathode material into the second openings and over the electrolyte layer on the second side of the silicon anode substrate.

The method of manufacturing the lithium-ion battery can include forming a cathode current collector on a surface of the cathode material, and forming a anode current collector on a surface of the first side of the silicon anode substrate. Forming the anode current collector can include conformally depositing a metal layer on the surface of the first side of the silicon anode substrate and forming a silicide with the metal layer. Forming the cathode current collector can include laminating a metal contact. The method can also include forming a plurality of units of the lithium-ion battery, wherein forming the plurality of units can include fabricating the units simultaneously in a batch format. In some implementations, forming the plurality of first openings can include laser drilling. In some implementations, forming the plurality of second openings can include laser drilling.

Another innovative aspect of the subject matter described in this disclosure can be implemented in a lithium ion battery. The lithium ion battery includes a silicon anode substrate having a plurality of first openings on a first side of the substrate, a cathode material over a second side of the silicon anode substrate opposite the first side, the cathode material extending within second openings on the second side of the silicon anode substrate, the second openings formed alternatingly with the first openings, and a solid electrolyte layer between the silicon anode substrate and the cathode material.

The lithium ion battery can further include a metallic cathode current collector on a surface of the cathode material, and a metallic anode current collector on a surface of the silicon anode substrate. The cathode current collector can include a metal laminate contact. In some implementations, the metal laminate contact can include extensions penetrating into the second openings through the cathode material. In some implementations, each of the first and second openings can have a height to width aspect ratio of greater than about 5:1.

Another innovative aspect of the subject matter described in this disclosure can be implemented in a lithium ion battery. The lithium ion battery includes a cathode material, a silicon substrate anode, means for conducting lithium between the cathode and the silicon substrate anode, and means for increasing the surface area of the cathode material and the silicon substrate relative to the planar electrodes.

Details of one or more implementations of the subject matter described in this specification are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIGS. 1A-1F show an example of a series of schematic cross-sections illustrating a process for manufacturing one implementation of a lithium-ion battery, and FIG. 1G is an example of an alternative to FIG. 1F for another implementation.

FIG. 1A shows an example of a silicon substrate.

FIG. 1B shows an example of a plurality of first openings on a first side of the silicon substrate with an anode current collector deposited thereover.

FIG. 1C shows an example of a plurality of second openings on a second side of the silicon substrate opposite the first side.

FIG. 1D shows an example of an electrolyte deposited on the second side of the silicon substrate and in the second openings.

FIG. 1E shows an example of a composite cathode material deposited in the second openings of the silicon substrate and over the electrolyte.

FIG. 1F shows an example of a cathode current collector formed over the cathode material.

FIG. 1G shows another example of a cathode current collector formed over the cathode material.

FIG. 2 shows a top plan view of the lithium-ion battery structure in FIG. 1F or 1G.

FIG. 3 shows an example of a flow diagram illustrating a manufacturing process for a lithium ion battery with a silicon anode substrate according to one implementation.

FIG. 4 shows an example of a flow diagram illustrating a manufacturing process for a lithium ion battery with a silicon anode substrate according to another implementation.

Like reference numbers and designations in the various drawings indicate like elements.

### DETAILED DESCRIPTION

The following detailed description is directed to certain implementations for the purposes of describing the innovative aspects. However, the teachings herein can be applied in a multitude of different ways. The described implementations pertain to rechargeable lithium-ion batteries, which may be implemented in several different types of devices ranging from portable electronics to electric vehicles. Thus, the teachings have wide applicability as will be readily apparent to a person having ordinary skill in the art.

In certain implementations, methods batch fabrication of a rechargeable lithium-ion battery are provided. The methods can include using silicon substrate as an anode. First openings can be formed on one side of the substrate, which can have a high height to width aspect ratio. Second openings can be laterally alternatingly formed with the first openings on another side of the substrate that is opposite the first side. The methods can further include depositing a solid electrolyte layer on the side of the substrate with the second openings, and forming a cathode material into the second openings and over the electrolyte layer.

Particular implementations of the subject matter described in this disclosure can be implemented to realize one or more of the following potential advantages. The use of silicon as the anode can enable batch fabrication that is scalable to large panel fabrication to reduce the cost of lithium-ion battery manufacturing. The low cost batch fabrication process also facilitates fabrication of prismatic (e.g., rectangular) cells, as prismatic cells generally have planar and thinner electrodes than, e.g., cylindrical cells. Relatively large prismatic cells can be produced with batch processing to reduce costs for a given capacity, especially for microelectronics or automotive applications. Additionally, the alternating first and second openings and the high aspect ratios provide high electrode area enhancement over a relatively large substrate, which leads to improved power and capacity. Also, the use of silicon as an anode instead of graphite provides much larger specific charge densities.

The primary functional components of a lithium-ion battery are the anode, cathode, and electrolyte. The anode of a conventional lithium-ion battery is often made from carbon, or more specifically, graphite. Yet graphite as the anode suffers from a lower specific charge capacity. Among candidates to replace graphite, silicon is promising because of its larger specific charge capacity and is one of the most abundant elements on earth. Thus, a lithium ion battery with a silicon anode can provide larger specific charge capacity while also enabling a large format batch process. Moreover, an ability to take advantage of the developing industrial infrastructure for producing and processing cast silicon substrates for the solar panel industry can lower production costs for large format, batch battery processing.

Lithium ions move from the anode to the cathode during discharge, and from cathode to anode when charging. For a silicon-lithium system, the basic battery cell diagram can be represented as Li|Li⁺-electrolyte|Si. When charging, lithium ions move from the cathode to the anode to form an alloy with the silicon. When discharging, lithium ions are extracted or de-alloyed from the lithium-silicon alloy.

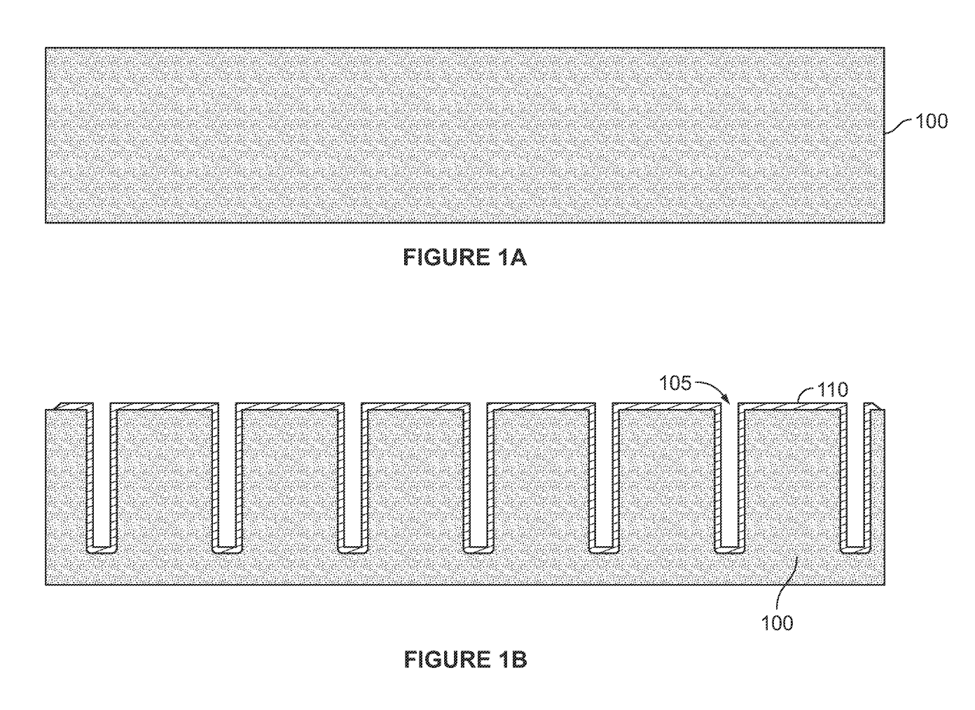

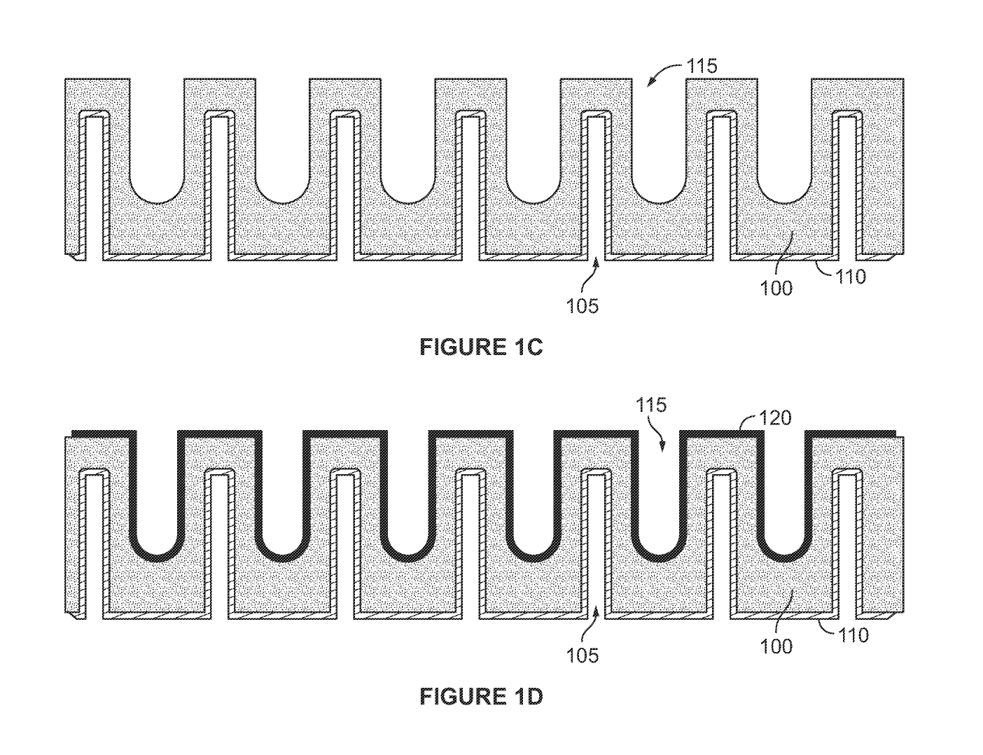

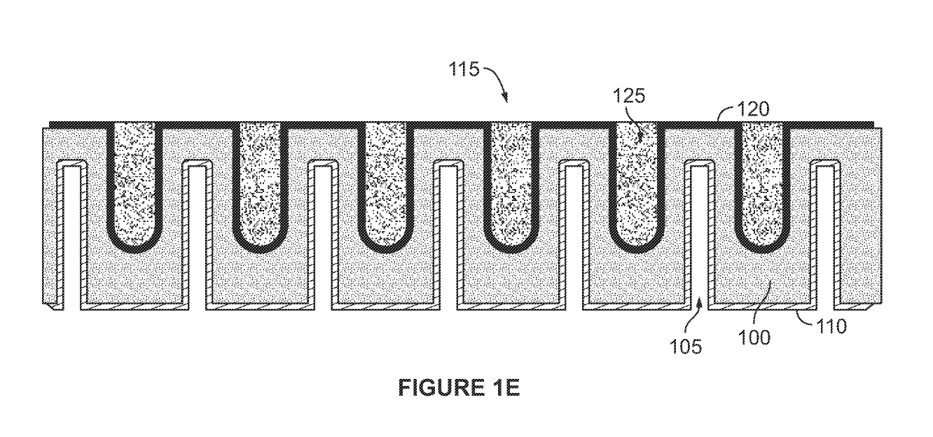

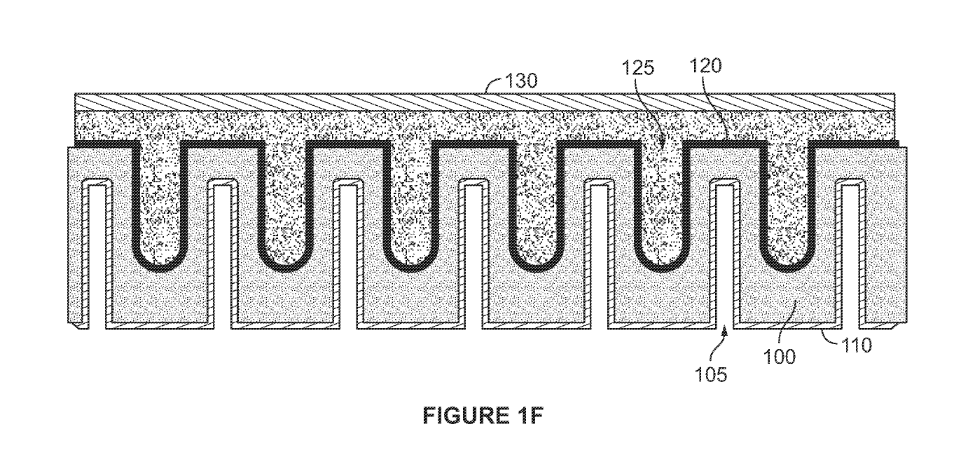

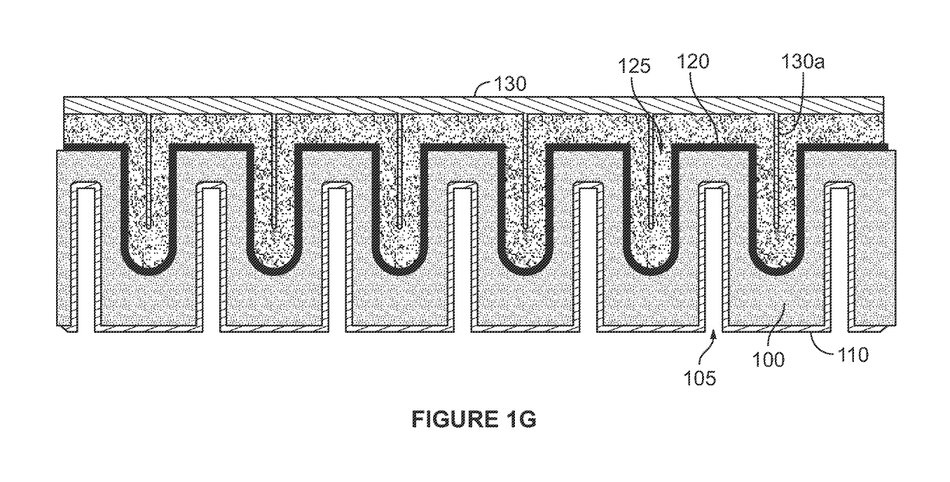

FIGS. 1A-1F show an example of a series of schematic cross-sections illustrating a process for manufacturing one implementation of a lithium-ion battery, and FIG. 1G is an example of an alternative to FIG. 1F for another implementation.

FIG. 1A shows an example of a silicon substrate 100. The silicon substrate 100 can serve as an anode in a lithium-ion battery structure. In a method of manufacturing a lithium-ion battery, a silicon substrate 100 can be provided. The silicon substrate 100 can be a pre-formed substrate, preferably a large cast or molded substrate of polysilicon. In some implementations, the silicon substrate 100 can be undoped and formed with minimal polishing. Moreover, the silicon substrate 100 can have a large thickness, such as a thickness of about 100 μm or more. In some implementations, the silicon substrate 100 can have a thickness of about 500 μm or more. One implementation of the substrate 100 can be a rectangular silicon substrate having length and width dimensions greater than 20 mm, e.g., greater than of about 25 mm to about 300 mm in width, and about 25 mm to about 450 mm in length. The rectangular wafer shape can be compatible with equipment for solar panel processing. Alternatively, the substrate 100 can be a circular silicon wafer having dimensions of about 25 mm to about 450 mm in diameter. The use of a large substrate of silicon provides for low cost, large format batch fabrication, and the use of cast polysilicon (undoped and minimally polished) can further reduce the cost of fabrication relative to, e.g., single crystal wafers. In some implementations, the silicon substrate 100 can be a silicon germanium substrate.

FIG. 1B shows an example of a plurality of first openings on a first side of the silicon substrate with an anode current collector deposited thereover. In some implementations, the first openings 105 can formed by laser drilling vias. In other implementations, mask and etch techniques can be used. By utilizing a laser beam, 3D structures such as vias can be formed without conventional photolithographic masks. Some types of lasers include, but are not limited to: CO₂ (wavelength of about 10.6 μm), Nd:YAG (about 1.06 μm), quadrupled Nd:YAG (about 266 nm), and excimer lasers (248 nm or 308 nm for organic materials, and 248 nm for ceramics). In certain implementations, the excimer laser is used for precision tasks such as drilling via sites while avoiding thermal effects of damage from heat affected zones.

A laser beam can drill up to hundreds or thousands of vias each second. For example, in one implementation for drilling the vias or first openings 105 each having a 10 μm diameter, it is possible to achieve 5,000 vias per second. The processing speeds of laser drilling increases throughput and streamlines fabrication, leading directly to higher yields for batch fabrication.

In addition, laser drilling of first openings 105 can achieve a high height-to-width aspect ratio. In some implementations, the first openings 105 have an aspect ratio of about 5:1, 8:1, 10:1, 40:1, or more. For example, in certain implementations the height (depth) can be from about 100 μm to about 800 μm, such as about 300-500 μm. The width (diameter) can be from about 1 μm to about 25 μm, such as about 8-12 μm. The openings 105 produced by laser drilling additionally provide stress relief for structures within the silicon substrate 100. More specifically, since lithium ions can intercalate with silicon, a volume change can result that introduces strain on the silicon substrate 100. However, openings 105 distributed across the substrate 100 can reduce the degree of strain occasioned by lithium ions intercalating with silicon.

FIG. 1B also illustrates deposition of an anode current collector 110 over the first openings 105 and the substrate 100. The anode current collector 110 is conductive and provides good electrical contact between terminals of the battery in the finished product. In some implementations, the anode current collector 110 is a metal silicide. The anode current collector 110 can be formed by conformally depositing a metal layer and then forming a silicide by reaction with the metal layer. Depositing the metal layer can be achieved, e.g., by electroless metallization, which can provide for conformal deposition while operating at a low cost and low processing temperature, though other deposition techniques can be employed. The formation of the silicide can be accomplished by rapid thermal anneal processing of the metal layer with the silicon substrate 100. When the anode current collector 110 is a metal silicide, good adhesion to the silicon substrate 100 results such that it is less likely to peel off during subsequent thermal processes.

FIG. 1C shows an example of a plurality of second openings on a second side of the silicon substrate opposite the first side. The second openings 115 can be formed laterally alternatingly with the first openings 105, such that the first openings 105 and second openings 115 are interdigitated. Cavities or vias forming the second openings 115 can be formed on the second side between first openings 105 of the first side. In some implementations, the second openings 115 can be wider than the first openings 105. The height-to-width aspect ratio of the second openings 115 can be 5:1, 8:1, 10:1, or more. For example, in certain implementations, the height (depth) can be from about 100 μm to about 800 μm, such as about 300-500 μm. And the width (diameter) can be from about 25 μm to about 100 μm, such as about 40-60 μm.

In some implementations, the second openings 115 can be formed by laser drilling, as described for the first openings 105. In other some implementations, the second openings 115 can be formed by masking and deep reactive ion etching (DRIE). DRIE can enable large-scale batch fabrication and produce high aspect ratio vias in silicon. The second openings 115 can also be formed by masking and sandblasting, which can provide for curved via formation. The sandblast process is performed by blasting particles of several microns or smaller at a high pressure. As a result, the second openings 115 can be formed having vertical sidewalls with curved sections near the mouths or shapes of circular truncated cones. The sandblast process enables large-scale batch fabrication and also the manufacture of the second openings 115 at a low cost because the time required for shaping the second openings 115 is short and does not require expensive apparatus. The sandblast process enables large-scale batch fabrication, and is readily scalable for larger substrates. Relative to sandblasting, however, laser drilling can more readily achieve high aspect ratios and smaller feature sizes.

FIG. 1D shows an example of an electrolyte deposited on the second side of the silicon substrate 100 and in the second openings 115. The electrolyte 120 provides an interface between the silicon substrate 100 (i.e., anode) and a cathode material 125, which is described below with respect to FIG. 1E, for ion conduction. In certain implementations, the electrolyte 120 is a solid electrolyte that can be deposited by molecular layer deposition (MLD). MLD provides conformal deposition of the solid electrolyte 120, preserving the high anode to cathode contact area provided by the alternated openings. In other implementations, the solid electrolyte 120 can be deposited by sputter deposition or chemical vapor deposition (CVD).

The power capability, safety, cycle life, and shelf life of the lithium ion battery depend at least in part on the solid electrolyte 120. Thus, the ion conductivity of the solid electrolyte 120 plays a significant role in the performance of the battery. In some implementations, the electrolyte 120 includes silicon-phosphorous glass or other ion conducting glass that can provide fast lithium ion transport, due to their high specific conductance. For example, the specific conductance of the solid electrolyte 120 can be between about 10⁻⁶ Ω⁻¹·cm⁻ and 10⁻³ Ω⁻¹·cm⁻¹. However, as conductivity is proportional to the distance between electrodes, even if the specific conductance of the ion conducting electrolyte is not very high, a thinner layer of electrolyte 120 can still provide for increased conductivity of lithium ion transport. In certain implementations, the electrolyte 120 can have a thickness of about 5.0 nm or less, or 2.5 nm or less.

FIG. 1E shows an example of a composite cathode material deposited in the second openings 115 of the silicon substrate 100 and over the electrolyte 120. In certain implementations, the cathode material 125 can be a conductive paste deposited by screen printing. Screen printing can be a cost-effective technique of depositing the cathode material 125 because it avoids the expenses of vacuum deposition or photolithography, while providing a high throughput.

The cathode material 125 can include an intercalated lithium compound as the electrode material. In some implementations, the cathode material 125 includes a composite porous structure. The composite porous structure can include a number of elements mixed together to form a paste, including a cathode active material, a binder, a diluent, and a conductive material. The active material can include a commercially available cathode compound, such as LiCoO₂, LiFePO₄, or LiMn₃O₄. The active material can be capable of reversibly intercalating lithium ions in its structure. The cathode compound can be in the form of small particles and can be mixed with a polymeric binder compound to form a paste. The polymeric binder can enhance the adhesion between the active material and the cathode current collector 130, described below with respect to FIGS. 1F and 1G. Some polymeric binders can include insulators, such as a polymer electrolyte like polyvinylidene fluoride (PVDF), polyacrylonitrile (PAN), poly-methyl methacrylate (PMMA), or mixtures thereof.

Furthermore, the cathode material 125 can include a diluent, such as a non-aqueous electrolyte solvent captured within the binder, e.g., gel type polymer electrolyte. Nonlimiting examples of suitable diluents include ethylene carbonate, propylene carbonate, dimethyl carbonate (DMC), or diethyl carbonate (DEC). Moreover, the non-aqueous electrolyte solvent can have a lithium salt dissolved therein, including but not limited to LiN(CF₃SO₂) or LiClO₄. The presence of the diluent with the lithium ion salt dissolved therein can increase mobility of lithium ions in the cathode material 125.

The cathode material 125 can also include electrically conductive material to enhance the conductivity of the cathode active material. One suitable example of electrically conductive particles can be carbon black particles. The individual particles of carbon are deployed as a means of increasing electrical conductivity between the cathode current collector 130, described below with respect to FIGS. 1F and 1G, and the cathode active material.

FIG. 1F shows an example of a cathode current collector formed over the cathode material 125. In some implementations, the cathode current collector 130 can be a metal foil or plate laminated over the cathode material 125. Examples of materials for the cathode current collector 130 include aluminum, copper, nickel, carbon, silver, titanium, and alloys thereof. In certain implementations, the current collector 130 can be made of aluminum. In FIG. 1F, the cathode current collector 130 can be substantially planar, and can be configured to connect with the anode current collector (not shown) of another lithium-ion battery unit. If the electronic conductivity of the cathode material 125 is high or if the power density required for the cathode is low, then the planar cathode current collector 130 shown in FIG. 1F can be employed.

The anode current collector 110 can be three dimensional in nature such that the anode current collector 110 conforms to the openings 105. The three dimensional nature of the anode current collector 110 can reduce the electronic resistance at the anode by reducing the average current path through the more resistive silicon substrate 100.

FIG. 1G shows another example of a cathode current collector formed over the cathode material 125. The cathode current collector 130 of FIG. 1G has extensions 130a penetrating into second openings 115 and through the cathode material 125. This configuration of the cathode current collector 130 can reduce the impedance of the cathode relative to the planar cathode current collector of FIG. 1F, and can allow more efficient functioning even at a higher power density for the cathode. In some embodiments, the cathode current collector 130 with extensions 130a can be fabricated on a separate substrate and then laminated in a manner that allows the extensions to penetrate the cathode material 125.

FIGS. 1F-1G illustrate implementations of lithium ion batteries with a silicon anode having a structure leading to improved power and capacity performance. As illustrated in FIGS. 1F-1G, the second openings 115 and first openings 105 have high aspect ratios and are formed alternatingly with respect to each other. This structure leads to increased contact area of the silicon substrate 100 and the cathode material 125 (i.e., electrodes) with the electrolyte 120. The methods described above are conductive to forming electrolyte 120 with a reduced thickness, and the second openings 115 and the first openings 105 with high aspect ratios, contributing to greater electrode contact area for the lithium-ion battery structure. The increased electrode area provides lower current density at the same operating current, which can provide higher power and energy capacity. Moreover, the planar arrangement of the lithium-ion battery can provide prismatic cells that can be readily embedded in microelectronics or automotive applications.

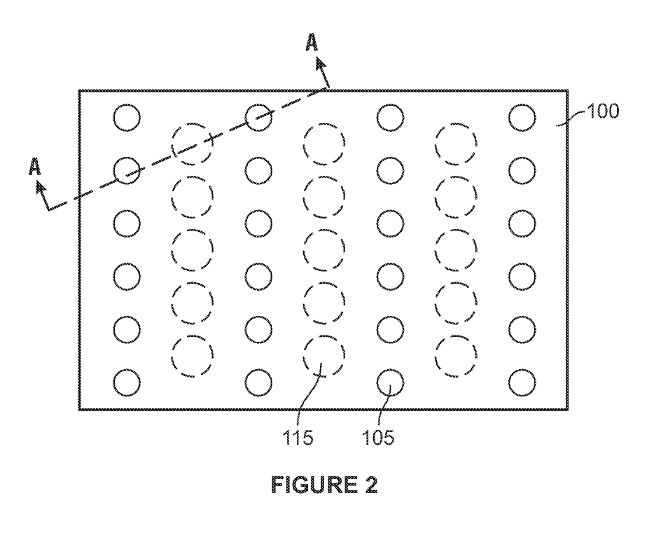

FIG. 2 shows a top plan view of the lithium-ion battery structure in FIG. 1F or 1G. As illustrated schematically in FIG. 2, the first openings 105 can be arranged linearly and alternatingly with the second openings 115 on the silicon substrate 100. The first openings 105 are formed on one side of the substrate 100 and the second openings 115 are formed on the opposite side of the substrate 100. In some implementations, the diameter of each of the second openings 115 is larger than the diameter of each of the first openings 105. While a full battery unit can have hundreds or thousands of first openings 105 and second openings 115, FIG. 2 illustrates only a small a section of a full battery unit. Thus, a full battery unit can be arranged on a substrate 100, in which the substrate 100 has a size and shape suitable for its application, e.g., rectangular substrate 100 having about 25 mm to 300 mm or larger in width, and about 25 mm to about 450 mm in length. In some implementations, the substrate is initially larger than the final battery shape and can be diced to a suitable shape after fabrication for better yield. In some implementations, a plurality of battery units (not shown) can be fabricated simultaneously in a batch format process. The plurality of battery units can be connected such that the anode current collector 110 of at least one of the battery units is in contact with the cathode current collector 130 of at least another one of the battery units. The planar arrangement of the substrate 100 can facilitate stacking of each unit so as to form a full lithium-ion battery in a prismatic (e.g., rectangular) cell.

Turning again to FIG. 1F or 1G, during discharge operation, lithium ions move in a direction from the anode, or silicon substrate 100, toward the cathode material 125 during discharge, and from cathode material 125 to the anodic silicon substrate 100 during charging. When charging, lithium ions move from the cathode material 125, by way of the solid electrolyte 120, to form an alloy with the anode, or silicon substrate 100 to form an alloy with the silicon. When discharging, lithium ions are extracted or de-alloyed from the lithium-silicon alloy formed on the anode, or silicon substrate, and move back to the cathode material 125 by way of the solid electrolyte 120. The alternated or interdigitated openings 105 and 115 from opposite sides of the substrate increase the surface area of the facing anode (silicon substrate 100) and cathode (cathode material 125), relative to planar electrodes. One having ordinary skill in the art will appreciate that the alternated structures on opposite sides of the silicon substrate 100 can have a variety shapes and sizes.

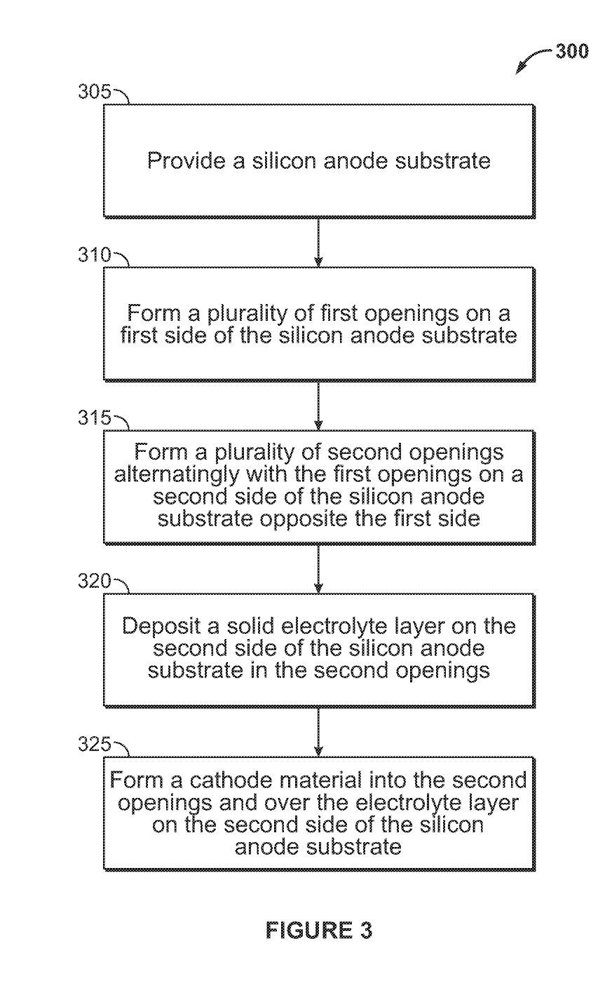

FIG. 3 shows an example of a flow diagram illustrating a manufacturing process for a lithium ion battery with a silicon anode substrate according to one implementation. Some of the blocks can be present in a process for manufacturing lithium-ion batteries of the general type illustrated in FIGS. 1A-2, along with other blocks not shown in FIG. 3. The process 300 includes block 305 where a silicon anode substrate is provided. The process continues at block 310, in which first openings are formed on a first side of the silicon anode substrate. At block 315, second openings are formed alternatingly with the first openings on a second side of the silicon anode substrate opposite the first side. The process 300 continues at block 320, where a solid electrolyte layer is deposited on the second side of the silicon anode substrate in the second openings. At block 325, a cathode material is formed into the second openings and over the electrolyte layer on the second side of the silicon anode substrate.

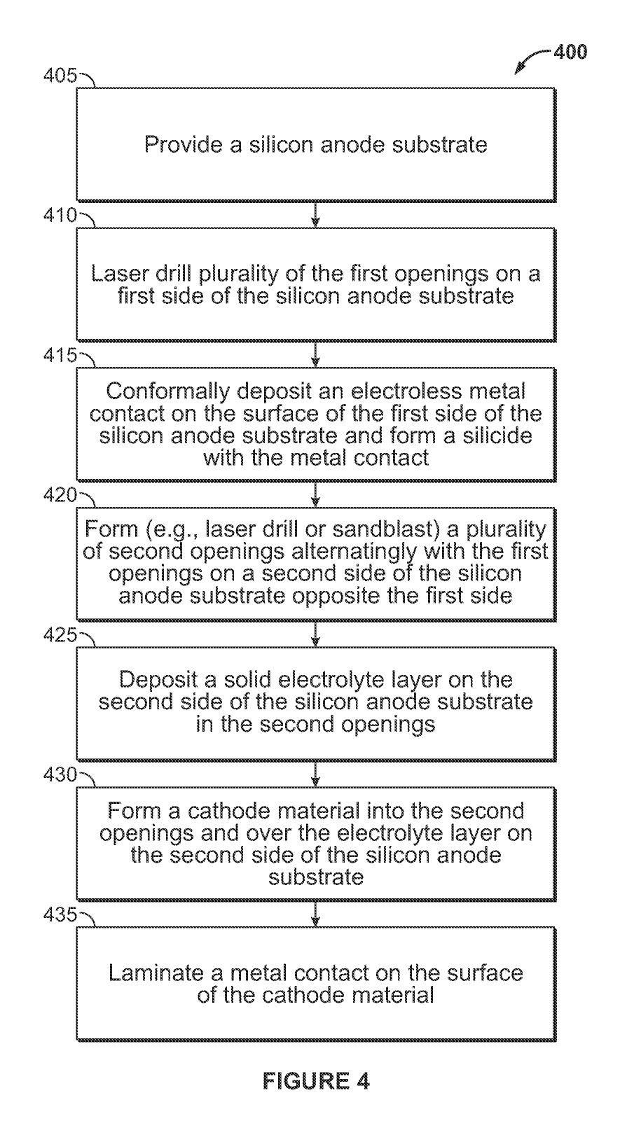

FIG. 4 shows an example of a flow diagram illustrating a manufacturing process for a lithium ion battery with a silicon anode substrate according to another implementation. The process 400 includes block 405, where a silicon anode substrate is provided. The process 400 continues at block 410, in which first openings are laser drilled on a first side of the silicon anode substrate. At block 415, a metal layer is conformally deposited on the surface of the first side of the silicon anode substrate and a silicide is formed with the metal layer. The process 400 continues at block 420, where second openings are formed (e.g., via laser drilling or sandblasting) alternatingly with the first openings on a second side of the silicon anode substrate opposite the first side. A solid electrolyte layer is deposited on the second side of the silicon anode substrate in the second openings at block 425. At block 430, a cathode material is formed into the second openings and over the electrolyte layer on the second side of the silicon anode substrate. The process 400 continues at block 435 where a metal contact is laminated on the surface of the cathode material.

Various modifications to the implementations described in this disclosure may be readily apparent to those having ordinary skill in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein. Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of the IMOD as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. A method of manufacturing a lithium-ion battery, comprising:
providing a silicon anode substrate;
forming a plurality of first openings on a first side of the silicon anode substrate;
forming a plurality of second openings alternatingly with the first openings on a second side of the silicon anode substrate opposite the first side;
depositing a solid electrolyte layer on the second side of the silicon anode substrate in the second openings; and
forming a cathode material into the second openings and over the electrolyte layer on the second side of the silicon anode substrate.

2. The method of claim 1, further including:
forming a cathode current collector on a surface of the cathode material; and
forming an anode current collector on a surface of the first side of the silicon anode substrate.

3. The method of claim 2, wherein forming the anode current collector includes:
conformally depositing a metal layer on the surface of the first side of the silicon anode substrate; and
forming a silicide with the metal layer.

4. The method of claim 2, wherein forming the cathode current collector includes laminating a metal contact.

5. The method of claim 4, wherein the metal contact includes extensions penetrating into the second openings through the cathode material.

6. The method of claim 2, further including forming a plurality of units of the lithium-ion battery, wherein forming the plurality of units includes fabricating the units simultaneously in a batch format.

7. The method of claim 6, further including connecting multiple ones of the units such that the anode current collector of at least one of the units is in contact with the cathode current collector of at least another one of the units.

8. The method of claim 1, wherein the silicon anode substrate includes polysilicon.

9. The method of claim 1, wherein forming the plurality of first openings includes laser drilling.

10. The method of claim 1, wherein forming the plurality of second openings includes laser drilling.

11. The method of claim 1, wherein forming the plurality of second openings includes sandblasting.

12. The method of claim 1, wherein each of the first openings has a height of from about 100 μm to about 800 μm and a width of from about 1 μm to about 25 μm, and each of the second openings has a height of from about 100 μm to about 800 μm and a width of from about 25 μm to about 100 μm.

13. The method of claim 1, wherein the silicon anode substrate is rectangular.

14. The method of claim 13, wherein the silicon anode substrate has a width of from about 25 mm to about 300 mm, and a length of from about 25 mm to about 450 mm.

15. The method of claim 1, wherein the forming the cathode material includes screen printing a composite porous paste, the composite porous paste including:
a material selected from the group consisting of LiCoO₂, LiFePO₄, or LiMn₃O₄;
a polymer electrolyte;
a liquid solvent within the polymer electrolyte;
a lithium ion salt; and
conductive particles.

16. A lithium ion battery produced by the method as recited in claim 1.

17. A lithium ion battery, comprising:
a silicon anode substrate having a plurality of first openings on a first side of the substrate;
a cathode material over a second side of the silicon anode substrate opposite the first side, the cathode material extending within second openings on the second side of the silicon anode substrate, the second openings formed alternatingly with first openings; and
a solid electrolyte layer between the silicon anode substrate and the cathode material.

18. The lithium ion battery of claim 17, further including:
a metallic cathode current collector on a surface of the cathode material; and
a metallic anode current collector on a surface of the silicon anode substrate.

19. The lithium ion battery of claim 18, wherein the anode current collector includes a metal silicide contact conformally lining the first openings.

20. The lithium ion battery of claim 18, wherein the cathode current collector includes a metal laminate contact.

21. The lithium ion battery of claim 20, wherein the metal laminate contact includes extensions penetrating into the second openings through the cathode material.

22. An apparatus including a plurality of units of the lithium ion battery of claim 16, wherein the units are connected such that the anode current collector of at least one of the units is in contact with the cathode current collector of at least another one of the units.

23. The apparatus of claim 22, wherein the silicon anode substrate includes polysilicon.

24. The lithium ion battery of claim 17, wherein the silicon anode substrate has a width of from about 25 mm to about 300 mm, and a length of from about 25 mm to about 450 mm.

25. The lithium ion battery of claim 17, wherein the silicon anode substrate includes polysilicon.

26. The lithium ion battery of claim 17, wherein each of the first and second openings has a height to width aspect ratio of greater than about 5:1.

27. The lithium ion battery of claim 26, wherein each of the first openings has a height of from about 100 μm to about 800 μm and a width of from about 1 μm to about 25 μm, and each second opening has a height of from about 100 μm to about 800 μm and a width of from about 25 μm to about 100 μm.

28. The lithium ion battery of claim 17, wherein the solid electrolyte layer includes a lithium ion conducting solid electrolyte.

29. The lithium ion battery of claim 17, wherein the solid electrolyte layer has a thickness of from about 1 nm to about 5 nm.

30. The lithium ion battery of claim 17, wherein the cathode material includes a composite porous structure, the composite porous structure including:
a material selected from the group consisting of LiCoO₂, LiFePO₄, or LiMn₃O₄;
a polymer electrolyte;
a liquid solvent within the polymer electrolyte;
a lithium ion salt; and
conductive particles.

31. A lithium ion battery, comprising:
a cathode material;
a silicon substrate anode;
means for conducting lithium between the cathode and the silicon substrate anode; and
means for increasing surface area of the cathode material and silicon substrate relative to the planar electrodes.

32. The lithium ion battery of claim 31, wherein the silicon substrate has a thickness of greater than about 100 μm.

33. The lithium ion battery of claim 31, wherein the means for conducting lithium includes a solid electrolyte layer.

34. The lithium ion battery of claim 31, wherein the means for increasing surface area includes a first plurality of openings on a first side of the substrate, and a second plurality of openings on a second side of the substrate opposite the first side, the first openings and second openings being interdigitated to be laterally adjacent one another.
